(19) United States
(12) Patent Application Publication
(10) Pub. No.: US 2005/0243688 A1
(43) Pub. Date: Nov. 3, 2005

(54) Optical scanning device

(76) Inventor: Johannes Joseph Hubertina Barbara Schleipen, Eindhoven (NL)

Correspondence Address: Philips Electronics North America Corporation;Corporate Patent Counsel, PO Box 3001, Briarcliff Manor, NY, 10510, US

(21) Appl. No.: 10/498,141

(22) PCT Filed: Nov. 27, 2002
(86) PCT No.: PCT/IB02/05030

§ 371 Date: Jun. 8, 2004

(30) Foreign Application Priority Data
Dec. 12, 2001 (EP) 01204799.9

(51) Int. Cl. G11B 7/00

(52) U.S. Cl. 369/125

(57) ABSTRACT

An optical head for scanning a dual-layer disk includes a polarising beam splitter for splitting an input beam (7) from a single radiation source to form two separate, orthogonally polarised beams (9, 10). One of the beams is passed trough a fixed collimator lens (13), whilst the other is passed trough a movable collimator lens (21). The beams are directed along a common beam path through a common objective lens (17) which is itself movably mounted. Focusing and terror correction is provided separately for each layer when scanning the two layers by actuation of the objective (17) and movable collimator (21), respectively. The use of a single radiation source and a single objective provides a reduction in the number of components, and the complexity of components, required to read a dual-layer disk.

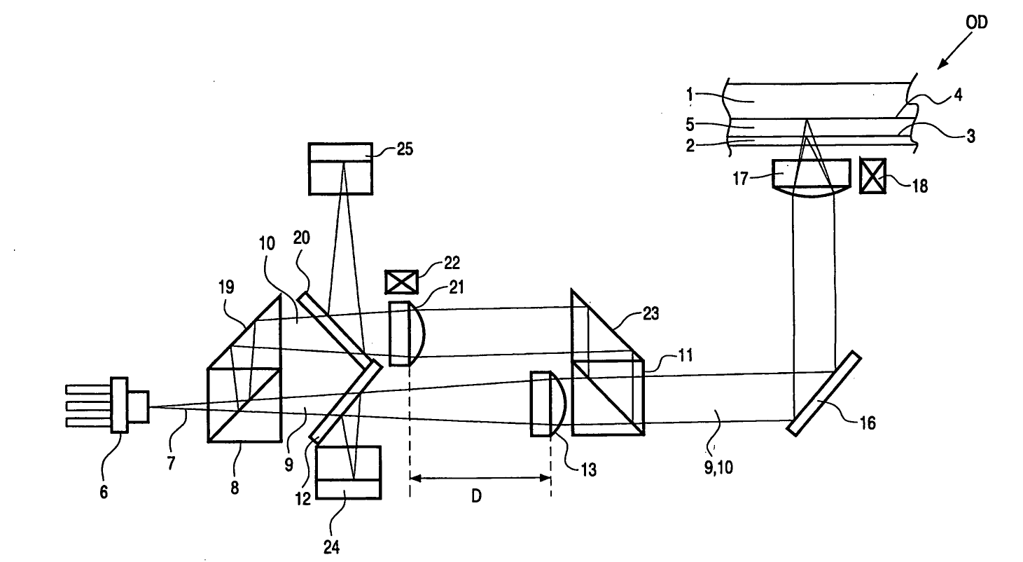

This invention relates to an optical scanning device, and an optical head for use therein, for scanning an optical record carrier. In particular, but not exclusively, the invention relates to a device for the simultaneous scanning of two different information layers of a multi-layer record carrier.

EP-A-0837455 describes an optical scanning device for scanning simultaneously at least two information layers and with partial beams which differ in terms of polarisation direction and propagation behaviour. The device includes a radiation source for supplying an input radiation beam, a polarising prism-type beam splitter, and a birefringent collimator lens for producing two different beams which are projected through an objective lens to scan the different information layers. The birefringent lens provides a wavefront difference between the beams to read different information layers, but does not allow for variations in the spacing between the different information layers, or variations in the position of tracks within the different information layers.

JP-A-10149560 describes an optical scanning device for scanning simultaneously at least two information layers. The device includes a radiation source for supplying one radiation beam, one beam splitter, one collimator lens, a polarisability element having an optically uniaxial birefringence (for transforming the radiation beam into two radiation beams which differ in terms of polarisation direction and propagation behaviour), and one objective lens. Again, the wavefront difference between the beams is fixed.

JP-A-2000195097 describes optical scanning (reading or writing) devices for scanning a plurality of information layers. In one embodiment, the device includes one objective lens and a plurality of radiation sources and associated beam splitters for coupling a first partial beam with a plurality of partial beams which are used to scan different information layers. Each of the plurality of partial beams passes through a separately movable element to modify the scanning characteristics of the beams for the different layers. In another embodiment, the device includes a plurality of objective lenses and a single radiation source producing a beam which is split towards the different objective lenses by polarising optics. Each of the different objective lenses is separately movable to modify the scanning characteristics of the beams for the different layers.

In accordance with the present invention there is provided an optical head for use in scanning a record carrier, said optical head being adapted to produce a first and a second beam for use in scanning said record carrier, wherein said optical head comprises a radiation source for generating an input radiation beam; a beam splitter for splitting said input radiation beam into a first beam and a second beam travelling along different forward paths; a variable wavefront modifier located in the forward path of said first beam and not in the forward path of said second beam, the wavefront modification characteristics of the modifier being variable in order to alter a relationship between said first and second beams; a beam redirector for directing said first and second beams along a common path; and an objective lens located in said common path, said objective lens being used to bring both said first and second beams to a focus in the record carrier.

Such an arrangement allows for the simultaneous read out of two information layers of a multi-layer record carrier, or of two different tracks of the same information layer of a record carrier, using only a single radiation source and a single objective, thereby to provide a reduction in the number of components, and the complexity of components, required.

Further features and advantages of the invention will become apparent from the following description of preferred embodiments of the invention, given by way of example only, made with reference to the accompanying drawings wherein:

The FIGURE is a schematic illustration of an optical scanning device in accordance with an embodiment of the invention.

The FIGURE is a schematic illustration of components common to a device, in accordance with a first embodiment of the invention, for scanning a dual-layer optical disk OD. The optical disk OD comprises a substrate 1 and a transparent layer 2, between which at least one information layer 3 is arranged. In the case of a dual-layer optical disk, as illustrated, two information layers 3, 4 are arranged behind the transparent layer 2, at different depths within the disk. A further transparent layer 5 separates the two information layers. The transparent layer 2 has the function of protecting the uppermost information layer 3, while mechanical support is provided by the substrate 1.

Information may be stored in the information layers 3, 4 of the optical disk in the form of optically detectable marks arranged in substantially parallel, concentric or spiral tracks, not indicated in the FIGURE. The marks may be in any optically readable form, e.g. in the form of pits, or areas with a reflection coefficient or a direction of magnetization different from their surroundings, or a combination of these forms.

The scanning device includes an optical pickup unit (OPU) mounted on a radially-movable arm. The OPU includes all components illustrated in the FIGURE, other than the disk OD. A radiation source 6, a single semi-conductor laser, emits a diverging linearly polarised radiation beam 7 of a predetermined wavelength. A first beam splitter 8, in this embodiment a polarising cubic beam splitter, transmits and reflects the radiation polarisation-dependent manner to create two separate orthogonally-polarised beams 9, 10 travelling along separate beam paths. A second beam splitter 11, in this embodiment a polarising cubic beam splitter, directs the beams 9, 10 to travel along a combined beam path towards an objective lens 17. The objective lens 17 is rigidly mounted within mechanical actuators 18 for performing radial tracking servo and focus servo adjustment of the position of the objective lens 17.

The radiation beam 9, which is transmitted by beam splitter 8, passes along the first beam path to a non-polarising beam splitter 12 which transmits a desired part of the beam. A fixed collimator lens 13 refracts the diverging radiation beam 9 to form a collimated beam. By collimated, we intend to mean a substantially parallel beam, for which the compound objective lens has a transverse magnification substantially equal to zero. The collimated beam preferably has a vergence resulting in an absolute magnification of the objective lens smaller than 0.02.

The first radiation beam travels, in its collimated state, through the second beam splitter 11 and, along the combined beam path, towards a folding mirror 16, where the beam is reflected towards the objective lens 17, which focuses the first beam 9 to a spot on the first information layer 3. The beam is reflected by the first information layer, and travels along a reverse path coincident with that of the incident beam, until the beam 9 reaches the non-polarising beam splitter 12, at which point a desired part of the beam is reflected towards detector systems 24, which include data detection circuits for detecting data read out from the first information layer 3, and focus and tracking error detection circuits for generating focus and tracking error detection signals which indicate deviations of the spot from the first information layer axially, and the centre of the currently scanned track, respectively. These first focus and tracking error signals are used to drive focus and tracking servo loops which control actuators 18 for controlling the axial and radial position of the objective lens 17 during scanning.

The radiation beam 10 which is reflected by beam splitter 8 and passes along the second beam path, is reflected by triangular prism 19 along a beam path parallel to the first beam path, in which the second radiation beam 10 passes through a non-polarising beam splitter 20. A movable collimator lens 21 refracts the diverging beam 10 to form a collimated beam. The collimated beam is reflected inside triangular prism 23 towards the second polarising beam splitter 11, at which the second beam 10 is reflected along the combined beam path towards the folding mirror 16 and the objective lens 17. The objective lens 17 focuses the second beam 10 to a spot on the second information layer 4. The second beam, on reflection from the second information layer 4, is transmitted along a reverse beam path coincident with the incident beam path until reaching the second non-polarising beam splitter 20, at which a desired part of the beam is output to detector systems 25. The detector systems 25 include a data detecting circuit for detecting a data signal corresponding to information read out from the second information layer 4, and tracking and focus error detection circuits for detecting focus and tracking errors due to axial displacement of the beam spot, relative to the second information layer 4, and radial displacement of the beam spot, relative to the centre of the track currently being scanned in the second information layer 4, respectively. These second focus and tracking error detection signals are used to drive focus servo loops which control mechanical actuators 22 for controlling the axial and radial positions of the collimator lens 21.

Thus, the objective lens 17, through which both beams pass, is controlled to optimise the scanning of information in the first information layer 3 using the first beam. The control of the movement of the objective lens 17 also affects the focusing and tracking position of the second beam 10. Variations in the distance between the two information layers 3, 4 during scanning are corrected, to ensure that the spot of the second beam stays on the information layer 4, by axial movement, under control of mechanical actuators 22, of the collimator lens 21. Differences in the radial positions of the tracks in the first and second information layers 3, 4 are corrected by radial movement, under control of mechanical actuators 22, of the collimator lens 21.

The default conjugate setting for the second beam 10 will be such that this beam is focused to a spot on the second information layer 4. Any variation in the distance between the two information layers is controlled by adjusting the position of the second collimator lens in a closed-loop servo. Since the tracks on both layers may not be stacked exactly on top of each other, eccentricity of the tracks is handled by a separate radial control loop for each information layer. The objective lens actuators 18 control the tracking for the first information layer 3 (and thereby also coarsely for the second information layer 4). Additional radial tracking for the second layer 4 is provided by means of the second collimator lens 21 and its actuators 22. Both servo loops can be operated independently.

If the eccentricity of the first information layer tracks is the same direction as for that of the second information layer (i.e. the centre of the tracks of the first information layer and the centre of the tracks of the second information layer are at the same side of the disc centre) the bandwidth of the collimator actuators 22 can be low. However, if the eccentricity of both layers have opposite direction, the radial bandwidth of the collimator actuators 22 should be twice the radial bandwidth of the objective lens actuator 518. Hence, to accommodate such disk tolerances, the collimator actuators 22 are preferably capable of operating at twice the operative radial bandwidth of the objective lens actuators 18.

No quarter wave plate is positioned in the light path, in order to preserve polarisation in forward and backward travelling laser beams. As a result the first beam a, being reflected from the first information layer 3, travels through movable collimator 21 again and is coupled via the non-polarising beam splitter 20 onto servo optics and the detector 25. The same holds for the second beam 10 reflected from the second information layer 4; it is focused by fixed collimator 13 via the non-polarising beam splitter 12 onto the detector 24.

The objective lens 17 should have sufficient field tolerance in order to accept the finite-conjugate second beam, having various possible angles of incidence with respect to the objective optical axis, due to radial actuating by movable collimator 21). The amount of field tolerance required depends on the relative eccentricity between both layers. For relatively small eccentricity (less than 50 tracks) a standard objective lens can be used. For higher values of eccentricity objective lenses having higher field tolerance should be used.

The following formulae are applied in the design of the lens system:
α_{field}=ε_{layer}/f_{obj} (1)
hᵣ=ε_{layer}·f_{coll}/f_{obj} (2)
hᵥ=δ_{layer}·f_{cell}²/f_{obj}² (3)
Fₚᵤₚ=d_{co}·α_{field}=d_{co}·ε_{layer}/f_{obj} (4)

In the above, the maximum radial excursion of the second layer spot with respect to the first layer spot is ε_{layer}, the variation in distance between both layers δ_{layer}, the optical path from collimator 21 to the objective lens d_{co}, the focal length of the objective 17 and collimator lens 21 respectively f_{obj} and f_{coll}, the maximum field angle of the second beam at the objective lens α_{field}, the maximum radial and vertical excursion of the collimator actuators hᵣ and hᵥ, respectively, and the required overfilling of the objective pupil by the second beam Fₚᵤₚ.

The objective lens 17 may consist of one or more lens elements. However, the objective lens, whether single or compound, has a single optical axis, along which both the first and second beams 9, 10 pass.

Each of the cubic polarising beam splitters 8, 11 are each preferably integrated with the triangular reflecting prisms 19, 23 respectively. The components may be bonded together, or formed as an integral component. Such integration increases manufacturing efficacy and, due to their rigid interrelation when integrated improves tolerances during production of the system.

Note, in the embodiment described, the collimator lens 13 in the first beam path and the collimator lens 21 in the second beam path are separated in the OPU by an axial distance D which corresponds generally with the width of the first beam splitter 8 and/or the height of triangular prism 19, in order to ensure that the collimated beams emerging from each of the collimator lenses are of approximate equal width.

Since a different collimator branch is used for each information layer, a static optical thickness can be positioned in one branch to compensate for spherical aberration introduced by the different information layer depth. Thus, spherical aberration wavefront error due to the difference in information layer depth of the two information layers 3, 4, may be corrected by differences in design of the collimator lenses 13, 21, or by the use of an additional spherical aberration compensating element in one of the branches.

The invention provides an optical head for scanning a dual-layer disk includes a polarising beam splitter for splitting an input beam from a single radiation source to form two separate, orthogonally polarised beams. One of the beams is passed through a fixed collimator lens, whilst the other is passed through a movable collimator lens. The beams are directed along a common beam path through a common objective lens which is itself movably mounted. Separate focusing and tracking error correction is provided when scanning the two layers by actuation of the objective and movable collimator, respectively. The use of a single radiation source and a single objective provides a reduction in the number of components, and the complexity of components, required to read a dual-layer disk.

The above embodiments are to be understood as illustrative examples of the invention. Further embodiments of the invention are envisaged. For example, whilst it is preferred that the first beam splitter 8 splitting the input beam is a polarising beam splitter, a non-polarising beam splitter may also be used, resulting however in a lower efficiency of transmission of the two beams when the two beams are directed along the common beam path by the second beam splitter 11. In this alternative embodiment, the second beam splitter is a polarising beam splitter which, when directing the two beam components along a common path, provides the components with orthogonal polarisations whereby the components are later separated when returning along the common path after reflection from different parts of the record carrier.

The invention is, in one embodiment, applied to the scanning of dual-layer Digital Versatile Disks (DVDs). However, the optical head of the invention is not limited in utility to the scanning of different information layers of a multi-layer record carrier. In an alternative, the two different beams may be used to scan different tracks of the same information layer.

Whilst a mechanical actuator system is described above in relation to the movement of the movable collimator lens 21, non-mechanical focus and/or tracking error correction may be used, for example employing the use of a liquid crystal cell, particularly where variations in focus and tracking error correction required for the two beams are relatively small. In this case most of the correction may be carried out by the mechanical actuators moving the objective 17, and the small remainder may be carried out by a non-mechanical, preferably lower bandwidth, variable wavefront modifier. This reduces the number of mechanical components required in the optical head.

It is to be understood that further equivalents and modifications not described above may also be employed without departing from the scope of the invention, which is defined in the accompanying claims.

1. An optical head for use in scanning a record carrier, said optical head being adapted to produce a first and a second beam for use in scanning said record carrier, wherein said optical head comprises:
a radiation source (6) for generating an input radiation beam;
a beam splitter (8) for splitting said input radiation beam into a first beam and a second beam travelling along different forward paths;
a variable wavefront modifier (21) located in the forward path of said first beam and not in the forward path of said second beam, the wavefront modification characteristics of the modifier being variable in order to alter a relationship between said first and second beams;
a beam redirector (11) for directing said first and second beams along a common path; and
an objective lens (17) located in said common path, said objective lens being used to bring both said first and second beams to a focus in the record carrier.

2. An optical head according to claim 1, being for use in scanning a record carrier having data stored therein on a plurality of information layers at a plurality of depths within the record carrier, wherein said head is adapted to use said first and second beams to scan different information layers simultaneously.

3. An optical head according to claim 1 or 2, wherein said beam splitter (8) comprises a polarising beam splitter.

4. An optical head according to claim 3, wherein said radiation source comprises a source producing substantially polarised radiation, and said source is arranged to produce radiation which is polarised at approximately 45° to a polarisation axis of said polarising beam splitter (8).

5. An optical head according to any preceding claim, wherein said beam redirector (11) comprises a polarising beam splitter.

6. An optical head according to any preceding claim, comprising an optical component arranged to receive the first and second beams when travelling along a common path after reflection from said record carrier, and to redirect the beams along different return paths.

7. An optical head according to claim 6, wherein said beam redirector (11) forms said optical component arranged to receive the first and second beams after reflection.

8. An optical head according to claim 6 or 7, wherein said different return paths each coincide in part with said different forward paths.

9. An optical head according to any of claims 6 to 8, wherein a beam redirector is arranged in each of the different return paths to pass the reflected beams towards first and second detectors, respectively.

10. An optical head according to claim 9, wherein said beam redirectors passing the reflected beams towards detectors each comprise a non-polarising beam splitter.

11. An optical head according to any preceding claim, wherein said variable wavefront modifier is capable of altering a focus relationship between said first and second beams.

12. An optical head according to any preceding claim, wherein said variable wavefront modifier is capable of altering a radial position relationship between said first and second beams.

13. An optical head according to any preceding claim, wherein said variable wavefront modifier comprises a mechanically actuable lens element.

14. An optical head according to any of claims 1 to 12, wherein said variable wavefront modifier comprises a non-mechanical variable wavefront modifier.

15. An optical scanning device comprising an optical head according to any of the preceding claims.
